(19) United States
(12) Patent Application Publication
(10) Pub. No.: US 2016/0179751 A1
(43) Pub. Date: Jun. 23, 2016

(54) VIARIABLE STRUCTURE REGRESSION

(71) Applicants: CHEVRON U.S.A. INC., San Ramon, CA (US); UNIVERSITY OF SOUTHERN CALIFORNIA, Los Angeles, CA (US)

(72) Inventors: Mohammad Mehdi Korjani, Los Angeles, CA (US); Jerry Marc Leon Mendel, Culver City, CA (US); Feilong Liu, Pleasant Hill, CA (US)

(21) Appl. No.: 14/974,827

(22) Filed: Dec. 18, 2015

Related U.S. Application Data
(60) Provisional application No. 62/094,922, filed on Dec. 19, 2014.

(51) Int. Cl. G06F 17/18

(52) U.S. Cl. CPC G06F 17/18

(57) ABSTRACT

Embodiments of a computer implemented method of generating a variable structure regression model. The method includes receiving data input including historical data, an output variable, a plurality of input variables; establishing a set of linguistic rules for the plurality of input variables; establishing variable structure regression equations using the set of linguistic rules, the output variable, the input variables, and the historical data; optimizing membership functions and regression coefficients of the variable structure regression equations; and generating a variable structure regression model from the optimized membership functions, the regression coefficients, and the variable structure regression equations. The exact mathematical structure of these linguistic terms and the number of terms are established simultaneously, thereby freeing the end user from trial and error time-consuming studies. Meanwhile, the knowledge of domain experts can be preserved, as qualitative expert knowledge may be combined with quantitative data.

### RELATED APPLICATION

This application claims the benefit of U.S. Patent Application No. 62/094,922, filed Dec. 19, 2014, entitled Variable Structure Regression, the content of which is incorporated herein by reference.

### TECHNICAL FIELD

The present application relates generally to regression and regression models.

### BACKGROUND

Regression models associate a measured output to a collection of measured variables, each of which is believed to contribute to the output. Such regression models are widely used in various science, engineering, behavioral science, biostatistics, business, econometrics, financial engineering, insurance, medicine, and petroleum engineering applications. Typical regression models have the following structure:

$$Output = Bias + {\sum }_{{R}_{s}} Coefficient \times Terms ,$$

where the Terms are the function of variables, and the Bias is a constant that does not depend on any of the variables, but the inclusion of such a term is common practice in developing regression models. Implementing a regression model introduces a variety of challenges, including the selection of variables, the selection of terms (also known as the regressors), selecting how many terms (hereinafter “Rₛ”) to include in the model, and optimizing the parameters that complete the description of the model. In real world applications, the specific nature of non-linear dependencies are usually unknown before the development of a regression model, and as such, the nonlinear dependencies are oftentimes chosen as combinations of linear products of variables, for example, two or three at a time. Additionally, the selection of Rₛ is typically performed, tediously, by trial and error. Furthermore, each Term is a parametric function of variables wherein numerical values are specified for all such parameters. If, for example, exponential functions are used for each Term, then numerical values for each exponent must also be provided.

### SUMMARY

In general terms, this disclosure is directed to a variable structure regression (hereinafter “VSR”) method, which includes a non-linear regression model.

In a first embodiment, the present disclosure is directed to a computer implemented method of generating a variable structure regression model. The method includes receiving data input including historical data, an output variable, a plurality of input variables; establishing a set of linguistic rules for the plurality of input variables; establishing variable structure regression equations using the set of linguistic rules, the output variable, the input variables, and the historical data; optimizing membership functions and regression coefficients of the variable structure regression equations; and generating a variable structure regression model from the optimized membership functions, the regression coefficients, and the variable structure regression equations.

In a second embodiment, the present disclosure is directed to a system for a system for generating a variable structure regression model. The system includes a computing device including a processor and a memory communicatively coupled to the processor, the memory storing computer-executable instructions which, when executed by the processor, cause the system to perform a method. The method includes receiving data input including historical data, an output variable, a plurality of input variables; establishing a set of linguistic rules for the plurality of input variables; establishing variable structure regression equations using the set of linguistic rules, the output variable, the input variables, and the historical data; optimizing membership functions and regression coefficients of the variable structure regression equations; and generating a variable structure regression model from the optimized membership functions, the regression coefficients, and the variable structure regression equations.

In a third embodiment, the present disclosure is directed to a computer-readable storage medium comprising computer-executable instructions which, when executed by a computing system, cause the computing system to perform a method. The method includes receiving data input including historical data, an output variable, a plurality of input variables; establishing a set of linguistic rules for the plurality of input variables; establishing variable structure regression equations using the set of linguistic rules, the output variable, the input variables, and the historical data; optimizing membership functions and regression coefficients of the variable structure regression equations; and generating a variable structure regression model from the optimized membership functions, the regression coefficients, and the variable structure regression equations.

A fourth embodiment, the present disclosure is directed to a method for forecasting post-fracturing responses in a subsurface reservoir. The method includes applying, via forecasting instructions executable on a computing system, a non-linear variable structure regression model to automatically establish non-linear regressors and select a number of non-linear regressors associated with historical hydraulic fracturing data, wherein each non-linear regressor is a combination of input variables, and each input variable includes a plurality of terms; and based on the non-linear variable structure regression model, generating a forecast of a post-fracturing response using the historical hydraulic fracturing data. The non-linear variable structure regression model determines relationships between fracturing parameters and post-fracturing productions in the form of one or more linguistic rules.

### BRIEF DESCRIPTION OF THE DRAWINGS

FIG. 1 illustrates an example oil field environment in which a variable structure regression model may be used.

FIG. 2 illustrates an example variable structure regression model as used in an example environment such as an oil field.

FIG. 3 is a flow chart of the variable structure regression model.

FIG. 4 is an example membership function when two clusters are used in a Fuzzy c-Means method.

FIG. 5 is an example right shoulder membership function.

FIG. 6 is a schematic block diagram of a computing system used to implement Variable Structure Regression model, according to an example embodiment.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

This disclosure is directed to a variable structure regression (hereinafter “VSR”) method, and more specifically, to a variable structure regression model that may be used, for example, for forecasting post-fracturing responses in a subsurface reservoir. A subsurface reservoir may be an oil reservoir or a tight oil reservoir. However, a subsurface reservoir may include practically any hydrocarbon, liquid, gas, etc. For simplicity, an oil reservoir or tight oil reservoir will be used herein.

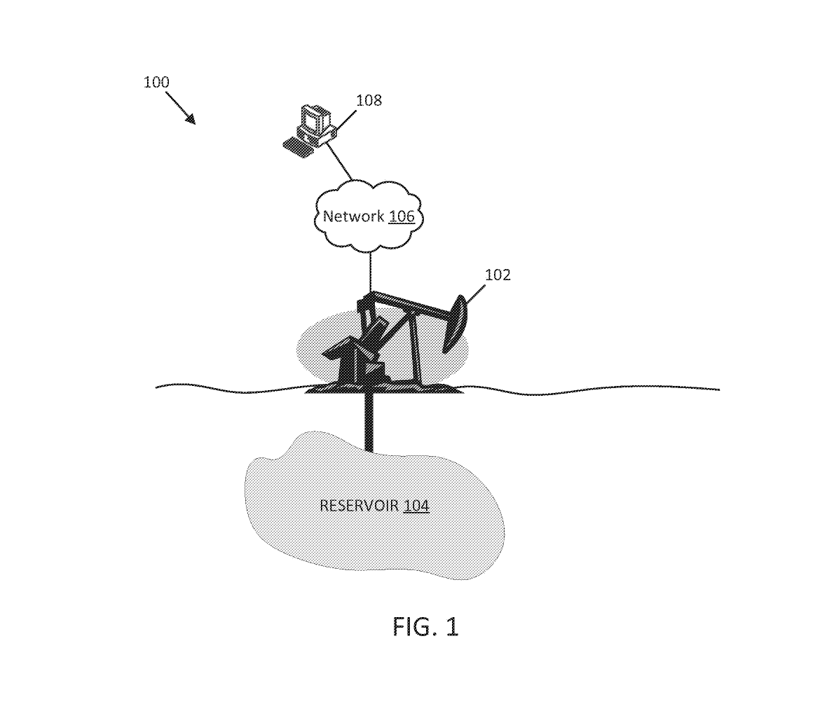

FIG. 1 is a diagram illustrative of an oilfield 100 using a variable structure regression model. FIG. 1 illustrates a wellhead 102 connected to a computing device 108 through a network 106. In the example oilfield 100, the wellhead 102 is located on a ground surface above an oil reservoir 104. The disclosed VSR method and system can be applied to a variety of different forecasting or predicting applications, such as the illustrated oilfield 100. In particular, the VSR method and system may be applied to predict oil production in response to various failures in such an example oilfield 100. Failures may occur in downhole equipment, such as with the oil tubing, the tubing anchor, or the rod string. Additionally, failure may occur due to a worn pump, a traveling valve leak, or a standing valve leak. Failures may additionally occur due to sediment and deposits stored or accumulating in the reservoir such as paraffin, asphalting, scaling, emulsions, sanding, or gas effects. Still further, failures may occur at the surface level, such as, stuffing box leaks, polished rod failure, gear box failure, bridle failure, sheave or belt failure, weight imbalance, valve leaks, wellhead leaks, or issues relating to the supervisory control and data acquisition system. Accordingly, the VSR method as described in further detail herein may be used to predict the production of oil due to such failures in the oilfield 100 using historically gathered data. In other words, the VSR method aims to forecast an outcome (i.e., oil production) based on historical data. However, this disclosure is not limited to forecasting post-fracturing responses nor predicting production of oil (or other hydrocarbon), and those of ordinary skill in the art will appreciate that this disclosure may be applicable to a number of other scenarios and data sets.

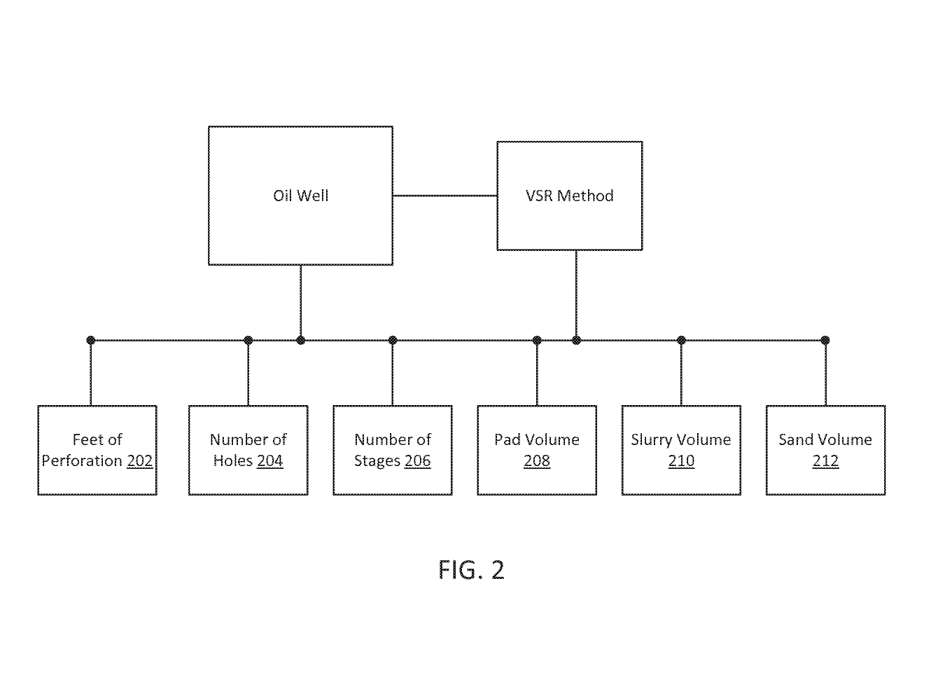

FIG. 2 illustrates an example variable structure regression model as used in an example oil field environment such as the oilfield 100 shown in FIG. 1. In particular, the method determines the number of regressors in a nonlinear regression model and further determines an optimal combination of variables in each of the regressors. In addition to using at least one linguistic term for each variable (e.g., a plurality of linguistic terms for each variable), the VSR model also uses the complement of that term. In application, the VSR method linguistically determines various relationships between input variables and an output variable, for example between fracturing parameters and post-fracturing oil production in order to provide a physical, concrete understanding of the effects of oil production after fracturing. The VSR method uses historical data, such as hydraulic fracturing data gathered from vertical wells. Such data includes, but is not limited to, the feet of perforation 202, the number of holes 204, the number of stages 206, the pad volume 208, the slurry volume 210, and the sand volume 212.

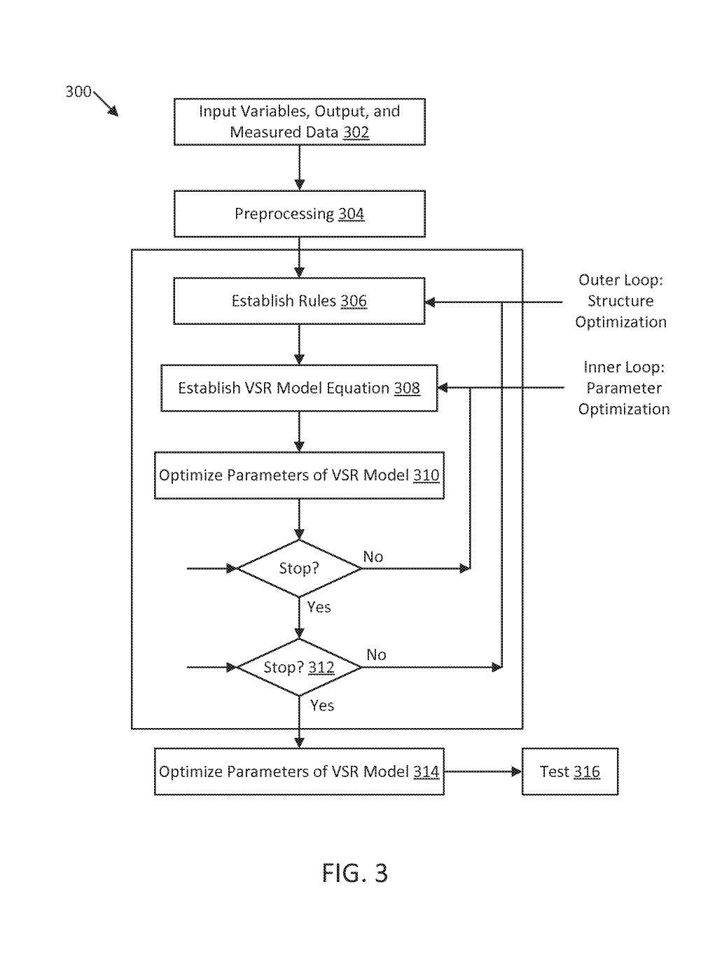

Now referring generally to FIG. 3. FIG. 3 illustrates a flow chart of the variable structure regression method 300. The VSR method 300 uses two types of parameters: linear parameters and non-linear parameters. The VSR method 300 uses optimization techniques to determine and optimize the linear and non-linear parameters. The VSR method may use, for example, least squares to optimize the linear parameters and may use, for example, Quantum Particle Swarm Optimization (hereinafter “QPSO”) to optimize the non-linear parameters that describe the terms, or the function of the variables. Although least squares and QPSO optimization techniques are described herein, other optimization techniques may alternatively be used. Furthermore, the parameters may be optimized using different approaches. In an example, the linear and non-linear parameters may be optimized simultaneously. Alternatively, the linear parameters may initially be optimized, followed by optimization of the non-linear parameters.

As described in further detail herein, the VSR method establishes optimal nonlinear dependencies of variables to predict cumulative oil production after fracturing has occurred in a vertical oil well. In some embodiments, the VSR method predicts cumulative oil production for about 180 days after fracturing, and in other embodiments, other durations for cumulative oil production are used.

The VSR method automatically selects a nonlinear structure of regressors and the number of terms to include in the regression model. Although the regression coefficient parameters are linear, the regressor basis functions are nonlinear, which are optimized iteratively by using, an optimization technique, such as, for example, least squares for the regression coefficient parameters and Quantum Particle Swarm Optimization for the regressor basis function parameters, after which the nonlinear structures of the regressors are also iterated upon in order to obtain the optimal structure of regressors. In embodiments, the VSR method uses a series of eight computational steps for forecasting post-fracturing responses in tight oil reservoirs.

The table below identifies key terminology as used throughout the disclosure:

| | |
|---|---|
| Aᵢ^{j} | Causal condition or its complement |
| β₀, βᵥ | Regression coefficients (v = 1, . . . , R_{S}) |
| Cᵢ (cᵢ) | Causal condition (complement) |
| f | Cut-off frequency threshold |
| Fⱼ | Causal combinations |
| fᵥ^{s} | R_{S} surviving causal combinations |
| g | Index of QPSO iteration, g = 1, . . . , G |
| G | Number of QPSO iteration |
| i | Index of causal conditions i = 1, . . . , k |
| j | Index of possible causal combinations j = 1, . . . , 2^{k} |
| J (Jₜᵣₙ, Jᵥₐₗ, Jₜₑₛₜ) | Objective function (training, validation, testing) |
| k | Number of causal conditions |
| l | Index of number of terms for each variable |
| | l = 1, . . . , n_{c} |
| m | Index of number of particles in the QPSO |
| | m = 1, . . . , M |
| M | Number of QPSO particles |
| μ_{A}_{ᵢ}_{^{j}} (t) | Membership value of the causal condition i or its |
| | complement for case t |
| μ_{C}_{ᵢ} (t) | Membership value of the causal condition i for case |
| | t |
| μ_{c}_{ᵢ} (t) | Membership value of complement of causal |
| | condition i for case t |
| μ_{F}_{ⱼ} (t) | Membership value of the causal combination j for |
| | case t |
| μ_{F}_{ᵥ}_{^{S}} (x) | Membership function of the surviving causal |
| | combination v |
| N (Nₜᵣₙ, N_{validation}, Nₜₑₛₜ) | Number of cases (training, validation, testing) |
| nᵢ = n_{c} | Number of terms per variable |
| p | Number of input variables |
| φᵥ (x₁, x₂, . . . , xₚ), φᵥ (x) | Regressors basis function |
| q | Index of number of input variables |
| rₘₐₓ | Maximum number of outer loop iteration |
| R_{S} | Number of regressors |
| S_{F} | 2^{k} candidate causal combinations |
| S_{Cases} (S_{Cases}^{trn}, S_{Cases}^{val}, S_{Cases}^{test}) | data pairs set (training, validation, testing) |
| t | Index of a case number |
| Tₗ (xᵢ) | Linguistic terms for each variable |
| θₘ | Optimization parameter |
| V | Index of surviving causal combination |
| | (v = 1, . . . , R_{S}) |
| x_{q} (x₁, x₂, . . . , xₚ) | Measured variables |
| y (yₜᵣₙ, yᵥₐₗ, yₜₑₛₜ) | Measured output (training, validation, testing) |

As described in further detail herein, a VSR model has the following structure:

y(x₁,x₂, . . . ,xₚ)=β₀+Σᵥ₌₁^{R}^{ₛ}βᵥφᵥ(x₁,x₂, . . . ,xₚ) Equation 1:

in which x_{q} are termed variables; the regressors φᵥ(x₁, x₂, . . . , xₚ) are nonlinear functions of x₁, x₂, . . . , xₚ. These nonlinear functions are often also called basis functions; βᵥ are the regression coefficients, and bias β₀ is a constant coefficient that does not depend on any of the variables; and, y(x₁, x₂, . . . , xₚ) is the output. Equation 1 is a linear regression model in coefficients because the regression coefficients are linear; however, the regressors are nonlinear functions of the variables. In some examples, basis functions may be polynomials (orthogonal and non-orthogonal), trigonometric, Gaussian, radial, fuzzy, or another suitable function.

FIG. 3 is a flow chart of the VSR method 300. Generally, FIG. 3 describes a flow of the computational steps, for example, for forecasting post-fracturing responses in tight oil reservoirs. The steps in the method 300 explain how the regressors [φᵥ (x)] and regression coefficients (βᵥ) are computed. Specifically, the flow starts with a data input step 302, in which the VSR method 300 accepts user-defined variables, output, and measured data as input in step 302. For example, step 302 can include receiving data input including historical data, an output variable, a plurality of input variables with each input variable described by at least one term (e.g., a plurality of input variables with each input variable described by a plurality of linguistic terms), and a quantity for each input variable that indicates the plurality of linguistic terms. For example, step 302 may receive a quantity of four to indicate four linguistic terms for a particular input variable, step 302 may receive a quantity of five to indicate five linguistic terms for another input variable, and so on.

Next, flow proceeds to a preprocessing step 304 in which linguistic terms are assigned to each of the p variables based on the received quantity for each variable. Step 304 may also include dividing the historical data into at least a training data subset, a validation data subset, and a testing data subset.

Next, in step 306, antecedent rules are established (e.g., the “if” part of the rule) as well as the number of rules. For example, step 306 may automatically establish a set of linguistic rules for the plurality of input variables. In other words, step 306 may automatically establish a set of regressors for the plurality of input variables, where the regressors are linguistic rules. Establishing the set of linguistic rules may include using the training data subset.

In step 308, the VSR equations are established. For example, step 308 may automatically establish variable structure regression equations using the set of linguistic rules, the output variable, the input variables, and the historical data. Establishing the variable structure regression equations may include using the training data subset.

In step 310, parameters, such as MF parameters and regression coefficients, of the VSR model are optimized. For example, step 310 may optimize membership functions and regression coefficients of the variable structure regression equations. Optimizing the membership function parameters and regression coefficients may include using both the training data subset and the validation data subset.

In step 312, the steps 308 and 310 are stopped according to a predefined stopping rule. In step 314, the final VSR model is established. For example, step 314 may generate a variable structure regression model (e.g., a non-linear variable structure regression model) from the optimized membership functions, the regression coefficients, and the variable structure regression equations. Generating the variable structure regression model may include using the training data subset and the validation data subset.

Finally, step 316 tests the VSR model obtained from step 314. For example, step 316 may include evaluating the generated variable structure regression model (e.g., evaluating the non-linear variable structure regression model) with the testing data subset of the historical data before finalizing the variable structure regression model (e.g., to establish a final variable structure regression model). The finalized variable structure regression model may be used for predictions and other applications.

In an example, a data pair is (x(t),y(t)) where x=col(x₁, x₂, . . . , xₚ) and y(t) is the output for that x(t). Each data pair is a “case” wherein the index t denotes a data case. In example aspects, there may or may not be a natural ordering of the cases over t. In a multi-variable function approximation application, the data have no natural ordering; but in a time-series forecasting application the data cases have a natural temporal ordering.

In simple validation, assume that there are N data pairs, wherein a collection of these data pairs are referred to as S_{cases}, where:

S_{Cases}={(x(t),y(t))}ₜ₌₁^{N} Equation 2:

N data pairs are divided into three data sets: a data set for training (adjusting model parameters), a data set for validation (using to estimate generalization error), and a data set for testing (evaluating the performance of the model). Of note, those of ordinary skill in the art will appreciate that data for one scenario may lead to a particular VSR model while data for a different scenario may lead to a difference VSR model. Thus, a VSR model as disclosed herein may be specific to the data (e.g., data driven), and therefore dividing the data into three data subsets (e.g., a training set, a validation set, and a testing set) will ensure that the VSR model is specific to the data and lead to more accurate results (e.g., more accurate predictions, etc.).

More specifically: 1) Nₜᵣₙ data cases form the training set, S_{Cases}^{trn}, where

S_{Cases}^{trn}={xₜᵣₙ(t):yₜᵣₙ(t)}ₜ₌₁^{N}^{ₜᵣₙ} Equation 3:

2) Nᵥₐₗ data cases form the validation set, S_{Cases}^{val}, where

S_{Cases}^{val}={xᵥₐₗ(t):yᵥₐₗ(t)}ₜ₌₁^{N}^{ᵥₐₗ} Equation 4:

and 3) Nₜₑₛₜ data cases form the testing set S_{Cases}^{test}, where

S_{Cases}^{test}={xₜₑₛₜ(t):yₜₑₛₜ(t)}ₜ₌₁^{N}^{ₜₑₛₜ} Equation 5:

The training data set is used to optimize the parameters of Equation 1; the validation data set is used to stop the training; and the testing data set is used to evaluate the overall performance of the optimized model.

Each variable xᵢ (i=1, . . . , p) is mapped into subsets of variables, wherein each variable has at least one linguistic term associated therewith (e.g., wherein each variable has a plurality of linguistic terms associated therewith). For example, the variable Pressure can be partitioned into a first term (e.g., Low Pressure), a second term (e.g., Moderate Pressure), and a third term (e.g., High Pressure). A membership function may be defined for each term of the variable, for example, a first membership function may be defined for the first term (e.g., Low Pressure) with a left-shoulder membership function, a second membership function may be defined for the second term (e.g., Moderate Pressure) with a middle membership function, and a third membership function may be defined for the third term (e.g., High Pressure) with a right-shoulder membership function. It is noted that there can be from 1 to nᵥ subsets (terms) for each input variable. The terms for each input variable are called causal conditions.

If only one term is chosen for each variable (e.g., Profitable Company, Educated Country, Permeable Oil Field, etc.), then the words “variable,” “term,” and “causal condition” can be used interchangeably. If, alternatively, more than one term is used for each variable (e.g., Low Pressure, Moderate Pressure and High Pressure), then the words “variable,” “term,” and “causal condition” are distinguished, as is described further, below.

If, for example, there are p variables, each described by nᵢ terms (i=1, . . . , p) then each of the terms are treated as a separate causal condition and, as a result, there will be k=n₁+n₂+ . . . +nₚ causal conditions.

The terms Tₗ(xᵢ)(l=1, . . . , nᵢ)(i=1, . . . , p) are denoted for each variable. For simplicity, the same number of terms are used for each variable, i.e. nᵢ=n_{c} for ∀i, so that the total number of causal conditions is k=n_{c}p.

The terms are organized according to the (non-unique) ordering of the p input variables, as {T₁(x₁), . . . , Tₙ_{_{c}}(x₁), . . . , T₁(xₚ), . . . , Tₙ_{_{c}}(xₚ)}. This set of n_{c}p terms is then mapped into an ordered set of causal conditions, S_{C}, as follows:

$$\{ {T}_{1} ( {x}_{1} ) , … , {T}_{{n}_{c}} ( {x}_{1} ) , … , {T}_{1} ( {x}_{p} ) , … , {T}_{{n}_{c}} ( {x}_{p} ) \} \to \{ {C}_{1} ( {x}_{1} ) , … , {C}_{{n}_{c}} ( {x}_{1} ) , … , {C}_{{n}_{c} ( p - 1 ) + 1} ( {x}_{p} ) , … , {C}_{{n}_{c} p} ( {x}_{p} ) \} ≡ \{ {C}_{1} , … , {C}_{{n}_{c}} , … , {C}_{{n}_{c} ( p - 1 ) + 1} , … , {C}_{{n}_{c} p} \} \qquad Equation 6$$

A causal combination is a connection of k=n_{c}p conditions, each of which is either a causal condition or its complement for each variable.

Assume three terms assigned to four input variables then p=4 and n_{c}=3, so that n_{c}p=12, and 2^{k}=2¹²=4096 causal combinations exist. An example of a causal combination is as follow:

Fⱼ=C₁c₂c₃C₄C₅C₆c₇c₈C₉c₁₀c₁₁c₁₂ Equation 7:

Where cᵢ denotes a complement of Cᵢ and multiplication denotes the AND operator that is modeled as the minimum conjunction. Equation 7 may be expressed as follows:

Fⱼ=Low(x₁) AND Not Moderate(x₁) AND Not High(x₁) AND Low(x₂) AND Moderate(x₂) AND High(x₂) AND Not Early(x₃) AND Not Midway(x₃) AND Late(x₃) AND Not Low(x₄) AND Not Moderate(x₄) AND Not High(x₄) Equation 8:

As described in further detail herein, the VSR method 300 eliminates erroneous or nonsensical combinations. For example, the VSR method 300 will eliminate the combination relating to the variable x₂ as simultaneously being Low, Moderate, and High.

Now referring to FIG. 1, in step 302, the VSR method 300 first receives variables, a desired output, and measured data as inputs to the system. Accordingly, the system accepts measured data for each variable as well as for the desired output in order to complete the design of the VSR regression model. Additionally, the end-user has dealt with missing data and outliers appropriately.

In step 304, the VSR method 300 employs preprocessing of the variables, the output, and the measured data. In the preprocessing step 304, linguistic terms are assigned to each of the p variables. A linguistic term is a label such as Low Upstream Pressure, Moderate Upstream Pressure and High Upstream Pressure. In embodiments, only two linguistic terms (for example, Low Upstream Pressure and High Upstream Pressure) are used for each variable in order to reduce the number of initial term-parameters in Equation 1.

As described herein, the number of linguistic terms is n_{c} and each linguistic term T is modeled as a type-1 fuzzy set. Accordingly, during the preprocessing step 304, membership functions (hereinafter “MFs”) are found for each term. In some embodiments, membership functions are defined using expert analysis and in other embodiments, prescribed functions are used as MFs (e.g., a two-parameter sigmoidal function or a two-parameter piecewise-linear function). Yet another way is to use a modified version of Fuzzy c-Means (hereinafter “FCM”). The MFs may be derived based on a variety of methods, wherein such a selected method is performed independently for each of the p variables. Regardless of how membership functions are found, in a later step of the VSR method, these MFs will be optimized and therefore changed.

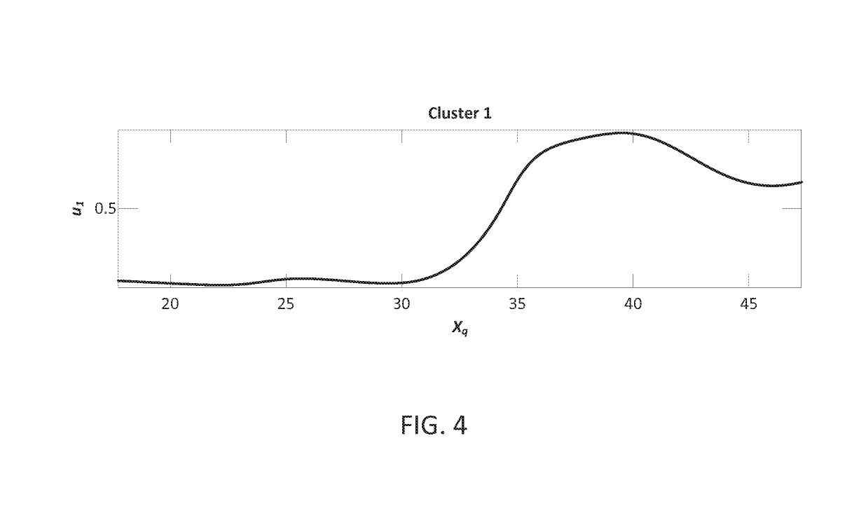

The MFs obtained are denoted μ₁ (x_{q}), where q=1, . . . , p; and l=1, . . . , n_{c}). As shown in FIG. 4, an example membership function is illustrated, which is derived using FCM. Although this example illustrates the use of FCM to derive MFs, the scope of this disclosure is not limited thereto and other methods may alternatively be used to derive MFs. In this example, two clusters (n_{c}=2) are used in the FCM. For example, FIG. 4 represents the use of two clusters, as would occur if two linguistic terms, such as Low Upstream Pressure and High Upstream Pressure, were used for each variable. Next, the FCM MF is modified using a method denoted the Linguistic Modified FCM (hereinafter “LM-FCM”) method. In the LM-FCM, four steps are used to modify the FCM MF. First, the method begins by defining the maximum and minimum breakpoints. An example maximum MF breakpoint is 1 and an example minimum breakpoint is 0. Then, for a right-shoulder cluster, all membership values to the right of the maximum breakpoint are set to 1 and membership values to the left of the minimum breakpoint are set to 0, while membership values between the breakpoints remain unchanged. A right shoulder MF begins from the left to the right with zero MF values and monotonically increases until it reaches a MF value of 1.

For a left shoulder cluster, all membership values to the left of the maximum breakpoint are set to 1 and membership values to the right of the breakpoint are set to 0, while membership values between the breakpoints remain unchanged. A left shoulder MF begins from left to right, which MF values equal to 1 and then monotonically decreases until it reaches a MF value of 0.

Finally, for an interior cluster, two minimum breakpoints are defined: one to the left and one to the right of the maximum membership. Membership values between the breakpoints remain unchanged and all other values are set to 0. An interior MF is first monotonically non-decreasing, after which it is monotonically non-increasing (e.g., the shape of a triangle).

Flow then proceeds to step 306 in which antecedent rules and the number of rules are established. In step 306, the VSR method 300 simultaneously establishes the if-part (the antecedent) of a rule, as well as the number of rules, Rₛ. The antecedent of each rule contains one linguistic term (or its complement) for each of the p variables, and each linguistic term is combined with the other linguistic terms using the word “and” (e.g., A₁ and A₂ and . . . and Aₖ; Pressure is Not Low and Pressure is Moderate and Pressure is Not High and Temperature is Low and Temperature is Not Moderate and Temperature is Not High). This interconnection is called a causal combination.

In embodiments, establishing rules begins in which 2^{k} candidate causal combinations (the 2 is due to both the term and its complement) are conceptually postulated, where k=n_{c}p. In the example above, where p=4 and n_{c}=3, there are 4096 causal combinations. Although there are 4096 causal combinations, it is not initially known which of the 2^{k} candidate causal combinations should be used as a compound antecedent in a rule. Accordingly, the VSR method 300 prunes these combinations by using the membership functions that were determined in step 304, as well as the membership function (using fuzzy set mathematics) for “A₁ and A₂ and . . . and Aₚ” and a simple test. The results are a distinct subset of rules, Rₛ, surviving the total number of causal combinations.

Let S_{F} be the collection of 2^{k} candidate causal combinations, Fⱼ, where j=1, . . . 2^{k}, and i=1, . . . , k, and k=n_{c}p):

$$\{ \begin{matrix}{S}_{F} = \{ {F}_{1} , … , {F}_{2 k} \} \\ {F}_{j} = {A}_{1}^{j} ⋀ {A}_{2}^{j} ⋀ {A}_{i}^{j} ⋀ … ⋀ {A}_{k}^{j} \\ {A}_{i}^{j} = {C}_{i} or {c}_{i}\end{matrix} \qquad Equation 9$$

Where [symbol] denotes an AND conjunction, where Cᵢ refers to a term, and where cᵢ refers to a complement of the term Cᵢ.

In some embodiments, the surviving causal combinations, Rₛ, are found using a three-step methodology. First, the 2^{k} candidate causal combinations are enumerated in a table having 2^{k} columns and Nₜᵣₙ rows, wherein each column includes one of the candidate causal combinations. Next, the MF for each of the 2^{k} candidate causal combinations is computed for each of the Nₜᵣₙ cases that are in the training set, S_{Cases}^{trn}. Accordingly, the entry of each element in the table having 2^{k} columns and Nₜᵣₙ rows is the MF value for each evaluated causal combination. Next, only those candidate casual combinations having MF>0.5 for at least f cases are kept, where f is a predetermined threshold.

Yet in alternative embodiments, for each case, only one of the 2^{k} candidate causal combinations has an MF value that is >0.5. Accordingly, in the table as described above, each row will contain only one element that is greater than 0.5.

For each case, only one of the 2^{k} candidate causal combinations has a MF value that is >0.5. More importantly, a formula called Min-Max Theorem is provided for establishing the candidate causal combination. According to the Min-Max Theorem, there are k causal conditions: C₁, C₂, . . . , Cₖ and their respective complements, c₁, c₂, . . . , cₖ. Considering the 2^{k} candidate causal combinations (j=1, . . . , 2^{k}) Fⱼ=A₁^{j}̂ . . . ̂ Aᵢ^{j} ̂ . . . ̂ Aₖ^{j} where Aᵢ^{j}=Cᵢ or cᵢ and i=1, . . . , k. Let

μ_{F}_{ⱼ}(t)=min{μ_{A}_{₁}_{^{j}}(t), . . . ,μ_{A}_{ᵢ}_{^{j}}(t), . . . ,μ_{A}_{ₖ}_{^{j}}(t)},t=1,2, . . . ,Nₜᵣₙ Equation 10:

where

μ_{A}_{ᵢ}_{^{j}}(t)=μ_{C}_{ᵢ}(t) or μ_{c}_{ᵢ}(t)=1−μ_{C}_{ᵢ}(t),i=1, . . . ,k Equation 11:

Accordingly, then for each t (case) there is only one j,j*(t), for which μ_{F}_{_{j*(t)}}(t)>0.5 and μ_{F}_{_{j*(t)}}(t) can be computed as:

μ_{F}_{_{j*(t)}}(t)=min{max(μ_{C}_{₁}(t),μ_{c}_{₁}(t)), . . . ,max(μ_{C}_{ₖ}(t),μ_{c}_{ₖ}(t))} Equation 12:

F_{j*(t)}(t) is determined from the right-hand side of (10), as:

$$\begin{matrix}{F}_{{j}^{*}} ( t ) = arg max ( {μ}_{{C}_{1}} ( t ) , {μ}_{{C}_{1}} ( t ) ) ⋀ … ⋀ \\ arg max ( {μ}_{{C}_{k}} ( t ) , {μ}_{{C}_{k}} ( t ) ) \\ = {A}_{1}^{{j}^{*} ( t )} ⋀ … ⋀ {A}_{k}^{{j}^{*} ( t )}\end{matrix} \qquad Equation 13$$

In Equation 11, argmax(μ_{C}_{ᵢ}(t), μ_{c}_{ᵢ}(t)) denotes the winner of max(μ_{C}_{ᵢ}(t), μ_{c}_{ᵢ}(t)), namely Cᵢ or cᵢ. In the equations described above, not all of the Nₜᵣₙ winning causal combinations will be different, but the same winning causal combination may occur for more than one case. Consequently, after the winning causal combination is found for each of the Nₜᵣₙ, cases, the J uniquely different F_{j*}(t) are found and are thereafter relabeled F_{j′} (j′=1, . . . , J).

The R_{S} surviving causal combinations are computed as:
1. Compute F_{j*}(t) using Equation 13.
2. Find the J uniquely different F_{j*}(t) and re-label them F_{j′} (j′=1, . . . , J).
3. Compute t_{F}_{_{j′}}, where (t=1, . . . , Nₜᵣₙ)

$${t}_{{F}_{{j}^{′}}} ( t ) = \{ \begin{matrix}1 & if {F}_{{j}^{′}} = {F}_{{j}^{*} ( t )} ( t ) \\ 0 & otherwise\end{matrix} \qquad Equation 14$$

4. Compute N_{F}_{_{j′}}, where

N_{F}_{_{j′}}=Σₜ₌₁^{N}^{ₜᵣₙ}t_{F}_{_{j′}}(t) Equation 15:
5. Establish the R_{S} surviving causal combinations Fᵥ^{S} (v=1, . . . , R_{S}), as:

$${F}_{v}^{S} = \{ \begin{matrix}{F}_{{j}^{′}} ( {j}^{′} \to v ) & if {N}_{{F}_{{j}^{′}}} \geq f \\ 0 & if {N}_{{F}_{{j}^{′ }}} < f\end{matrix} \qquad Equation 16$$

where F_{j′}(j′→v) means F_{j′} is added to the set of surviving causal combinations as Fᵥ^{S}, and v is the index of the surviving set.

Next, flow proceeds to step 308 wherein VSR equations are established. The R_{S} surviving causal combinations lead to the following TSK rules

Sᵥ:IF x₁ is A₁^{v} . . . and xₚ is Aₖ^{v}, THEN yᵥ(x)=βᵥ,v=1, . . . ,R_{S} Equation 17:

where the constants βᵥ have yet to be determined (they will be the regression coefficients).

The MF of the antecedents of each rule is μ_{F}_{ᵥ}_{^{s}}(x), where:

μ_{F}_{ᵥ}_{^{S}}(x)=μ_{A}_{₁}_{^{v}}(x₁)★μ_{A}_{₂}_{^{v}}(x₂)★ . . . ★μ_{A}_{ₖ}_{^{v}}(xₚ)) Equation 18:

Note that μ_{F}_{ᵥ}_{^{s}}(x) is a highly non-linear function of the input variables because it non-linearly depends on each MF of its input variable, μ_{A}_{₁}_{^{v}}(x₁), and the MFs connected by the t-norms.

As described herein the VSR uses two models for the AND operation: the minimum and the product. The minimum is used in step 306, in which the subset of the 2^{k} candidate causal combinations that should survive is determined. The product is used in step 308 to allow the regression model to be a continuous function of its variables. The formula for VSR expansion begins with Equation 18 and assumes that fired rules are aggregated using center of sets (COS) defuzzification:

$$γ ( x ) = \frac{{\sum }_{v = 1}^{{R}_{S}} {β}_{v} {μ}_{{F}_{v}^{S}} ( x )}{{\sum }_{v = 1}^{{R}_{s}} {μ}_{{F}_{v}^{S}} ( x )} . \qquad Equation 19$$

Equation 19 can also be written as follows:

$$γ ( x ) = {\sum }_{v = 1}^{{R}_{s}} {β}_{v} [ \frac{{μ}_{{F}_{v}^{S}} ( x )}{{\sum }_{v = 1}^{{R}_{S}} {μ}_{{F}_{v}^{S}} ( x )} ] . \qquad Equation 20$$

In regression modeling a bias, β₀, is added. Such a bias transforms Equation 20 as follows:

$$y ( x ) = y ( x ) = {β}_{0} + γ ( x ) = {β}_{0} + {\sum }_{v = 1}^{{R}_{S}} {β}_{v} [ \frac{{μ}_{{F}_{v}^{S}} ( x )}{{\sum }_{v = 1}^{{R}_{S}} {μ}_{{F}_{v}^{S}} ( x )} ] . \qquad Equation 21$$

Accordingly, Equation 21 is now in the form of a fuzzy basis function (FBF) expansion in which the FBFs, denoted φᵥ(x), are:

$${ϕ}_{v} ( x ) ≡ \frac{{μ}_{{F}_{v}^{S}} ( x )}{{\sum }_{v = 1}^{{R}_{S}} {μ}_{{F}_{v}^{S}} ( x )} . \qquad Equation 22$$

Equation 22 can be expressed as follows:

y(x)=β₀+Σᵥ₌₁^{R}^{_{S}}βᵥφᵥ(x). Equation 23:

Equation 23 is known as the VSR regression model. The VSR model can be normalized such that:

Σᵥ₌₁^{R}^{ₛ}φ(x)=1 Equation 24:

Once optimal values have been found for β₁, . . . , β_{R}_{_{S}}, it is possible to map each of the regression coefficients into a fuzzy set that is associated with an output word, such as Low, Moderate, and High. In so doing, the number of words to be used for the output (e.g., Low, Moderate, and High) are determined. The same number of clusters are then used when LM FCM is applied to {yₜᵣₙ(t)}ₜ₌₁^{N}^{ₜᵣₙ}. Next, each βᵥ is located on they axis and is projected vertically so that it intersects one or more of the determined MFs for yₜᵣₙ. Finally, the word that is associated with each βᵥ is chosen to be the one with the largest of these MF values. Accordingly, by using this method, each rule in Equation 22 can be provided with a linguistic interpretation.

Next, flow moves to step 310, where parameters, such as MF parameters and regression coefficients, of the VSR model are optimized. As described herein, the VSR model includes two types of parameters: MF parameters, which appear in the fuzzy basis functions, and regression coefficients. Both parameters must be determined before Equation 24 is satisfied. In some embodiments, this may be done by determining both the MF parameters and regression coefficients simultaneously by means of one nonlinear optimization. In other embodiments, this is done by determining the MF parameters and regression coefficients separately, but iteratively, and iterating between a linear optimization for the regression coefficient parameters and a nonlinear optimization for the MF parameters. In embodiments, the VSR method uses the latter approach because each of the optimization problems is of lower dimension than would be the combined optimization problem.

Thus, to optimize regression coefficients, the least squares (LS) method is used to find the regression coefficients, β₀, and βᵥ (where v=1, . . . , Rₛ) by using the training data as described herein. The training data is also used to compute the training error. In addition, the validation data is used to compute a validation error that is used to find the overall optimized VSR model, as is explained in more detail herein.

Using the notations in Equations 11 and 12:

yₜᵣₙ(t)=β₀+Σᵥ₌₁^{R}^{_{S}}βᵥφᵥ(xₜᵣₙ(t)), where t=1, . . . ,Nₜᵣₙ. Equation 25:

yᵥₐₗ(t)=β₀+Σᵥ₌₁^{R}^{_{S}}βᵥφᵥ(xᵥₐₗ(t)), where t=1, . . . ,Nᵥₐₗ. Equation 26:

Equations 25 and 26 may be expressed in vector-matrix format as follows:

$$\begin{matrix}{y}_{trn} = {Φ}_{trn} β & Equation 27 \\ {y}_{val} = {Φ}_{val} β & Equation 28 \\ {y}_{trn} = {[ {y}_{trn} ( 1 ) , … , {y}_{trn} ( {N}_{trn} ) ]}^{T} & Equation 29 \\ {y}_{val} = {[ {y}_{trn} ( 1 ) , … , {y}_{val} ( {N}_{val} ) ]}^{T} & Equation 30 \\ β = {[ {β}_{0} , {β}_{1} , {β}_{2} , … , {β}_{{R}_{S}} ]}^{T} & Equation 31 \\ {Φ}_{trn} = [ \begin{matrix}1 & {ϕ}_{1} ( {x}_{trn} ( 1 ) ) & … & {ϕ}_{{R}_{S} ( {x}_{trn} ( 1 ) )} \\ ⋮ & ⋮ & ⋱ & ⋮ \\ 1 & {ϕ}_{1} ( {x}_{trn} ( {N}_{trn} ) ) & … & {ϕ}_{{R}_{S}} ( {x}_{trn} ( {N}_{trn} ) )\end{matrix} ] & Equation 32 \\ {Φ}_{val} = [ \begin{matrix}1 & {ϕ}_{1} ( {x}_{val} ( 1 ) ) & … & {ϕ}_{{R}_{S} ( {x}_{val} ( 1 ) )} \\ ⋮ & ⋮ & ⋱ & ⋮ \\ 1 & {ϕ}_{1} ( {x}_{val} ( {N}_{val} ) ) & … & {ϕ}_{{R}_{S}} ( {x}_{val} ( {N}_{val} ) )\end{matrix} ] & Equation 33\end{matrix}$$

The least-squares optimized regression coefficients, β_{LS}, obtained by minimizing J(β)=(∥yₜᵣₙ−Φₜᵣₙβ∥²/Nₜᵣₙ)^{0.5} can be expressed as β_{LS}=(Φₜᵣₙ^{T}Φₜᵣₙ)⁻¹Φₜᵣₙ^{T}yₜᵣₙ

Next, the Singular Value Decomposition (SVD) method is used to compute β_{LS}. Once β_{LS} is computed, the training and validation errors are computed as follows:

Jₜᵣₙ(∥yₜᵣₙ−Φₜᵣₙβ_{LS}∥²/Nₜᵣₙ)^{0.5} Equation 34:

Jᵥₐₗ(∥yᵥₐₗ−Φᵥₐₗβ_{LS}∥²/Nᵥₐₗ)^{0.5} Equation 35:

Note that in order to compute Φₜᵣₙ in Equation 32, the basis functions must be evaluated at the Nₜᵣₙ data in the training data set. This is done using the MFs that were obtained in step 304 of FIG. 1. In order to compute Φᵥₐₗ in Equation 33, the basis functions are evaluated at the Nᵥₐₗ data in the validation data set.

As described herein, step 310 also includes optimizing MF parameters; however, when the MF parameters change, the basis functions in Equation 22 also change because the basis functions use the MFs that were obtained in step 304 of FIG. 1. Additionally, the linearly optimized regression coefficients are also changed. Consequently, there is a natural iteration (G iterations) between optimizing the regression coefficients and optimizing the MF parameters.

In this step, the same surviving R_{S} causal combinations that were found in step 306 of FIG. 1 may be used, however, because the MFs are changed in the present step, step 306 is later repeated.

In order to optimize the MF parameters, a parametric model for each MF is selected. In example embodiments, piecewise linear MF models, and Quantum Particle Swarm Optimization are used as a MF parameter optimization method. Although Quantum Particle Swarm Optimization is used herein, it is known to one of ordinary skill in the art that other optimization procedures may alternatively be used.

As described herein, in order to minimize the number of parameters, linguistic terms are selected for each variable. For example, the terms Low and High are selected for each variable.

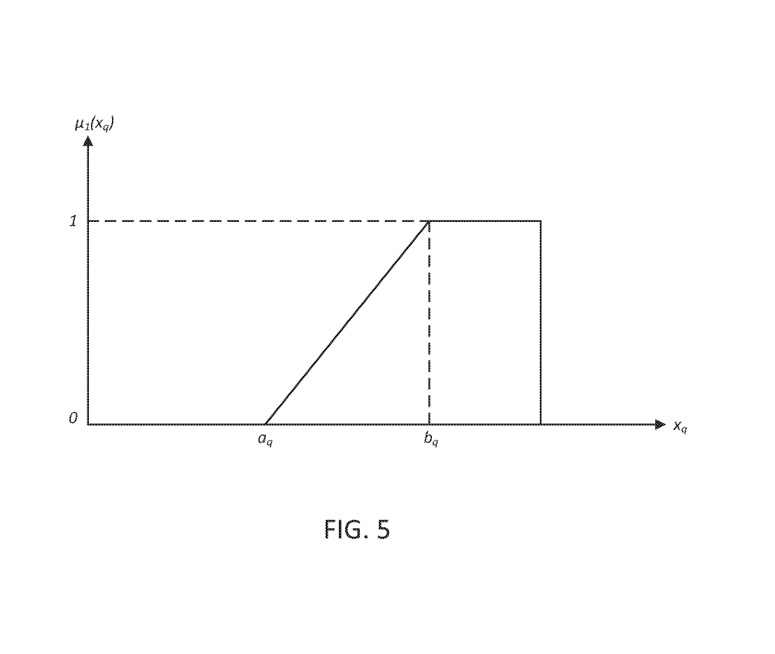

As shown in FIG. 5, for a right-shoulder MF corresponding to a term of a variable (e.g., corresponding to the term High Pressure of the variable Pressure), the MF model is:

$${μ}_{H} ( {x}_{i} ) = \{ \begin{matrix}0 & {x}_{i} < {a}_{i}^{r} \\ \frac{{x}_{i} - {a}_{i}^{r}}{{b}_{i}^{r} - {a}_{i}^{r}} & {a}_{i}^{r} < {x}_{i} < {b}_{i}^{r} \\ 1 & {x}_{i} > {b}_{i}^{r}\end{matrix} \qquad Equation 36$$

For a left-shoulder MF corresponding to another term of the same variable (e.g., corresponding to the term Low Pressure of the variable Pressure), the MF model is:

$${μ}_{L} ( {x}_{i} ) = \{ \begin{matrix}1 & {x}_{i} < {a}_{i}^{l} \\ \frac{{x}_{i} - {a}_{i}^{l}}{{b}_{i}^{l} - {a}_{i}^{l}} & {a}_{i}^{r} < {x}_{i} < {b}_{i}^{l} \\ 0 & {x}_{i} > {b}_{i}^{l}\end{matrix} \qquad Equation 37$$

For a middle MF corresponding to yet another term of the same variable (e.g., corresponding to the term Moderate Pressure of the variable Pressure), the MF model is

$${μ}_{M} ( {x}_{i} ) = \{ \begin{matrix}0 & {x}_{i} < {a}_{i}^{m} \\ \frac{2}{{b}_{i}^{m} - {a}_{i}^{m}} \vert {x}_{i} - \frac{{a}_{i}^{m} + {b}_{i}^{m}}{2} \vert + 1 & {a}_{i}^{m} < {x}_{i} < {b}_{i}^{m} \\ 0 & {x}_{i} > {b}_{i}^{m}\end{matrix} \qquad Equation 38$$

As described herein, QPSO is a globally convergent iterative search algorithm that does not use derivatives, but generally outperforms general Particle Swarm Optimization techniques and has fewer parameters to control. QPSO is a population-based optimization technique, where a population is called a swarm that contains a set of M different particles. Each particle represents a possible solution to an optimization problem (for example, in some embodiments, the optimization problem is minimization). The position of each particle is updated (in each QPSO iteration) by using the most recent, best solution; the mean of the personal best positions of all particles; and the global best solution found by all particles.

In some embodiments, QPSO is used to optimize the MF parameters by minimizing the objective function Jₜᵣₙ(θₘ)=∥yₜᵣₙ−Φₜᵣₙ(θₘ)β_{LS}∥². The MF parameters that have been collected into vector θₘ are in the matrix (see Equation 32) and are randomly initialized. In some embodiments, the first time QPSO is performed, the initial MF parameters are found from the LM-FCM MFs.

Optimization is performed a predetermined (G) number of times (we chose G=200 iterations), for example, for G=50 iterations, however, if objective function values for two consecutive inner loop iterations are very close (e.g., ≦ε₀) then inner loop iterations are stopped. For each of the G iterations optimization, for example using QPSO, generates new MFs for each of the M particles, so that new basis functions and regression coefficients are needed for each of these particles; hence, for each of the G iterations QPSO iterates back to step 308 and then to step 310 for each of the M particles. As described herein, the structures of rules do not change during the QPSO optimization process. For each of the G iterations, the particle that has the smallest validation error is saved (the prior best-particle). After G iterations the model that has the smallest validation error is found and saved. For example:

$$\begin{matrix}{θ}_{m}^{*} = arg {min}_{{g = 1 , … , G}_{m = 1 , … , M}} {J}_{val} ( {θ}_{m} ( g ) ) = arg {min}_{{g = 1 , … , G}_{m = 1 , … , M}} {‖ {y}_{val} - {Φ}_{val} ( {θ}_{m} ( g ) ) {β}_{LS} ( {θ}_{m} ( g ) ) ‖}^{2} & Equation 39 \\ {J}_{val} ( {θ}_{m}^{*} ) = {( {‖ {y}_{val} - {Φ}_{val} ( {θ}_{m}^{*} ) {β}_{LS} ( {θ}_{m}^{*} ) ‖}^{2} / {N}_{val} )}^{0.5} & Equation 40\end{matrix}$$

The value θ*ₘ establishes the parameters [φᵥ(x|θ*ₘ) and β_{LS}(θ*ₘ)] for the winning model, which is expressed, in the first iteration where r=1, as follows:

y(x|θ*ₘ)=β_{LS,0}(θ*ₘ)+Σᵥ₌₁^{R}^{_{S}}β_{LS,v}(θ*ₘ)φᵥ(x|θ*ₘ) Equation 41:

Equation 41 describes what occurs during the inner loop of FIG. 1, namely, for each outer loop iteration, r, there are G inner loop iterations. And for each such iteration there is one best particle (g); the best of these G particles is the one that has the smallest validation error [θ*ₘ]; its parameters are used in Equation 41 to describe the best model for each outer loop iteration, r.

Thus, after G iterations of steps 308 and 310 (the inner loop of FIG. 1), the method flows to step 312 (the outer loop of FIG. 3). Until the stopping rule is satisfied, the method 300 proceeds to step 306 in order to modify the structures of the causal combinations. Note that prior to step 310, all the MF s were obtained from the LM-FCM, however the optimization technique disclosed in step 310 changed the MFs.

Step 312 is performed a predetermined (rₘₐₓ) number of times. In some embodiments, rₘₐₓ=100 iterations and in other embodiments, other iterative amounts are used, or iterations are performed until the same set of rules appears in any one of the rₘₐₓ QPSO iterations.

The rₘₐₓ iterations of the outer loop (steps 306-312) lead to rₘₐₓ models {y^{(r)}(x)}ᵣ₌₁^{r}^{ₘₐₓ}, each obtained as explained by Equation 41 and described by {{φᵥ^{(r)}(x|θ*ₘ(g(r))), β_{LS,v}^{(r)}(θ*ₘ(g(r)))}ᵥ₌₁^{R}^{_{S}}^{(r)}, Jᵥₐₗ^{(r)}(θ*ₘ(g(r)))}ᵣ₌₁^{r}^{ₘₐₓ}.

Now proceeding to step 314, a final model is established.

Pseudocode for steps 306-312 is as follows:

TABLE V
Pseudo-code for Steps 3-6

Initialize MFs using LM-FCM;
Select rₘₐₓ (Number of iterations for outer loop)

Using the Training data set:
Compute surviving causal combinations
Create rules: Sᵥ^{(r)}
If Sᵥ^{(r)} appears in previous iterations

Stop

Else

Set M to Number of Particles
Set G to Number of generations
If g ≦ G AND |Jₜᵣₙ^{(r)}(g(r + 1)) − Jₜᵣₙ^{(r)} (g(r))| > ε₀

Find FBFs
Find LS coefficients
Find Optimized MFs
g = g +1

```
  End
  Using the validation data set:
  Find the winning model using (44)
```

Store Jᵥₐₗ^{(r)} (g * (r)), Φᵥₐₗ^{(r)} = Φᵥₐₗ (g * (r)),
β^{(r)} = β_{LS}^{(r)}(g * (r)), and Sᵥ^{(r)}

Set r = r + 1

End

End

As illustrated, for each iteration of the outer loop (namely, steps 306-312), the training data set is used to compute surviving causal combinations and to create rules. Accordingly, the following model is obtained:

$$\begin{matrix}{y}^{*} ( x ) = {β}_{LS , 0}^{( {r}^{*} )} ( {θ}_{m}^{*} ( g ( {r}^{*} ) ) ) + {\sum }_{v = 1}^{{R}_{S} ( {r}^{*} )} {β}_{LS , v}^{( {r}^{*} )} ( {θ}_{m}^{*} ( g ( {r}^{*} ) ) ) {ϕ}_{v}^{( {r}^{*} )} ( x \vert {θ}_{m}^{*} ( g ( {r}^{*} ) ) ) & Equation 42 \\ {r}^{*} = arg {min}_{r = 1 , … , {r}_{max}} {J}_{val}^{( r )} ( {θ}_{m}^{*} ( g ( r ) ) ) & Equation 43\end{matrix}$$

The method may flow to step 316, wherein the method evaluates the optimized regression model obtained from step 314 using an independent set of testing data. More information about testing is provided at Korjani et al., “Non-linear Variable Structure Regression (VSR) and its Application in Time-Series Forecasting,” 2014 IEEE International Conference on Fuzzy Systems (FUZZ-IEEE), pp. 497-504, Jul. 6-11, 2014, Beijing, China, which is incorporated by reference in its entirety and for all purposes. The following reference, In particular, MF values for the testing data are computing from Equation 36, and the basis functions of the testing data are obtained as follows:

$${Φ}_{test} = [ \begin{matrix}1 & {ϕ}_{1} ( {x}_{test} ( 1 ) ) & … & {ϕ}_{{R}_{S}} ( {x}_{test} ( 1 ) ) \\ ⋮ & ⋮ & ⋱ & ⋮ \\ 1 & {ϕ}_{1} ( {x}_{test} ( {N}_{test} ) ) & … & {ϕ}_{{R}_{S}} ( {x}_{test} ( {N}_{test} ) )\end{matrix} ] \qquad Equation 44$$

The testing error is computed as follows:

Jₜₑₛₜ(θ*ₘ)=(∥yₜₑₛₜ−Φₜₑₛₜ(θ*ₘ)β_{LS}(θ*ₘ)∥²/Nₜₑₛₜ)^{0.5} Equation 45:

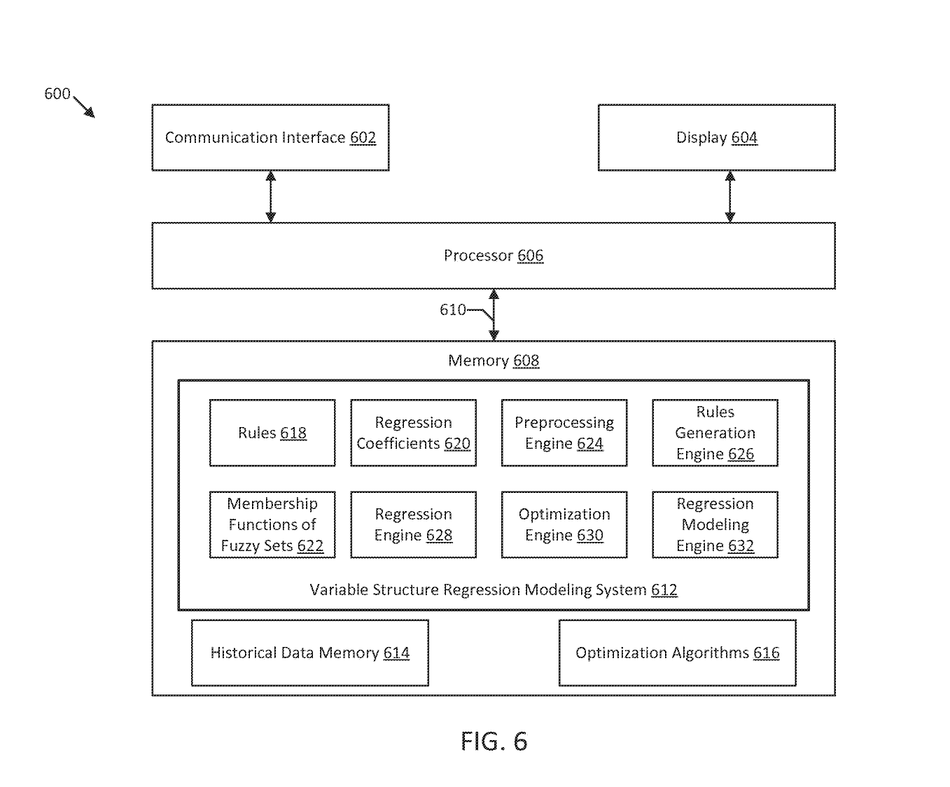

Referring now to FIG. 6, a schematic block diagram of an example computing system 600 used to implement the VSR model is shown. The computing system 600 can be, in some embodiments, used to implement the VSR model. In general, the computing system 600 includes a processor 606 communicatively connected to a memory 608 via a data bus 610. The processor 606 can be any of a variety of types of special-purpose or general-purpose programmable circuits capable of executing computer-readable instructions to perform various tasks, such as mathematical and communication tasks.

The memory 608 can include any of a variety of memory devices, such as using various types of computer-readable or computer storage media. A computer storage medium or computer-readable medium may be any medium that can contain or store the program for use by or in connection with the instruction execution system, apparatus, or device. By way of example, computer storage media may include dynamic random access memory (DRAM) or variants thereof, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer storage media generally includes at least one or more tangible media or devices. Computer storage media can, in some embodiments, include embodiments including entirely non-transitory components. In the embodiment shown, the memory 608 stores a VSR modeling system 612, which represents a computer-executable application that can implement the VSR method 300 discussed in further detail herein.

However, those of ordinary skill in the art will appreciate that an “application” is not necessary to implement the VSR method, and instead, for example, the memory 608 may store computer instructions executable by the processor 606 to carry out the disclosed operations described in this disclosure. Both the processor 606 and the memory 608 may be physical items. Furthermore, in some embodiments, at least one programmable logic controller (PLC) may be utilized to carry out the disclosed operations described in this disclosure.

Returning to the memory 608, the memory 608 additionally includes a historical data memory 614 for storing the historical data associated with the variables discussed herein. The memory 608 further includes optimization algorithms 616 for storing various optimization algorithms used to optimize the linear and nonlinear parameters as described herein.

The computing system 600 can also include a communication interface 602 configured to receive data streams and transmit notifications as generated by the VSR modeling system 612, as well as a display 604 for presenting various indicators or issues relating to a system under observation. The communication interface 602 and/or the display 604 may also be coupled to any number of input/output devices, for example, for receiving user input (e.g., expert data).

The VSR modeling system 612 is used to forecast post-fracturing responses in an oil reservoir. The VSR modeling system 612 may be applied to determine the number of regressors in a nonlinear regression model and to determine an optimal combination of variables in each of the regressors. Generally, the VSR modeling system 612 includes rules 618, regression coefficients 620, membership functions of fuzzy sets 622. In example embodiments, the VSR modeling system 612 further includes a preprocessing engine 624 that executes the preprocessing step 304 as described in FIG. 3. In this example, the VSR modeling system 612 also includes a rules generation engine 626 for establishing rules for each variable and a regression engine 628 that establishes the VSR equations themselves. As illustrated in this example, the VSR modeling system 612 further includes an optimization engine 630 for optimizing the linear and non-linear parameters and a regression modeling engine 632 for generating a nonlinear VSR model.

Accordingly, variable structure regression is a nonlinear regression model that automatically and simultaneously selects the nonlinear structure of regressors and the number of terms to include in the regression model. This model is linear in the regression coefficient parameters and nonlinear in the basis function parameters. Its parameters are optimized iteratively using optimization techniques such as, for example, least squares for the regression coefficient parameters and Quantum Particle Swarm Optimization for the basis function parameters, after which the nonlinear structures of the regressors are also iterated upon. Furthermore, provided is previse structural information about the dependence of each antecedent on either the term or its complement, but also provides the number of terms in the basis function expansion, Rₛ.

There may be a variety of applications for this VSR technology. First, the VSR technology may be utilized for non-linear regression, including, for example, using high frequency rod pump data to predict low frequency gauge data. The VSR technology may provide better predictions than linear regression models. Indeed, in a highly non-linear system, this VSR technology has the potential to perform much better than linear regression when the associated model is non-linear. This VSR technology may have the ability to automatically choose the important rules, which could correspond to a special area or zone, and establish the best fit by iterative training.

Second, the VSR technology may be utilized for pattern classification, including for example, for well failure detection as discussed hereinabove. The VSR technology may lead to wholly automated, fewer false alarms, high (e.g., approximately 90%) failure detection, and better predictions than linear regression models.

Third, the VSR technology may be utilized for knowledge extraction or data mining, including, for example, with respect to drilling, shale gas, etc. For example, the VSR technology may be used to better understand the data and lead to better decision making, or in other words, to understand the values that will lead to an outcome or output. Indeed, a VSR model may be generated with input data about the zones of a subsurface reservoir, the depth(s), the location(s), the quantity of proppants, the quantity of fracturing fluid, the well completion, the number of perforations, and others, for example, to determine a well design that may lead to higher hydrocarbon production. Other examples may include, but are not limited to, predicting pump failures, predict oil and water after fracturing, predicting light gas oil, and forecasting production rate. Specifically, the generated VSR model may predict output based on new data. The VSR technology may be used for data driven production prediction.

Various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer-implemented method of generating a variable structure regression model by a computing device, the computer comprising:
receiving data input including historical data, an output variable, and a plurality of input variables;
establishing, by the computing device, a set of linguistic rules for the plurality of input variables;
establishing, by the computing device, variable structure regression equations using the set of linguistic rules, the output variable, the input variables, and the historical data;
optimizing, by the computing device, membership functions and regression coefficients of the variable structure regression equations; and
generating, with the computing device, a variable structure regression model from the optimized membership functions, the regression coefficients, and the variable structure regression equations.

2. The method of claim 1, wherein each input variable is described by a plurality of linguistic terms, and further comprising receiving a quantity for each input variable that indicates the plurality of linguistic terms.

3. The method of claim 2, wherein each linguistic rule is an antecedent of the output variable, and further wherein each antecedent contains the plurality of terms for the input variables.

4. The method of claim 1, wherein generating the variable structure regression model includes determining simultaneously, with the computing device, a number of non-linear regression parameters and a structure of one or more regressors.

5. The method of claim 1, wherein the linguistic rules describe physical characteristics within the historical data.

6. The method of claim 1, further comprising organizing, with the computing device, each input variable and the output as a data pair.

7. The method of claim 1, wherein the set of linguistic rules are a set of if-then rules that are quantified using fuzzy sets and fuzzy logic.

8. The method of claim 1, wherein optimizing the membership function parameters involves using a quantum particle swarm optimization algorithm and determining regression coefficients involves using a least squares method.

9. The method of claim 1, further comprising dividing, with the computing device, the historical data into at least a training data subset, a validation data subset, and a testing data subset.

10. The method of claim 9, wherein:
establishing the set of linguistic rules includes using the training data subset,
establishing the variable structure regression equations includes using the training data subset,
optimizing the membership function parameters and regression coefficients includes using both the training data subset and the validation data subset, and
generating the variable structure regression model includes using the training data subset and the validation data subset.

11. The method of claim 9, further comprising evaluating, with the computing device, the generated variable structure regression model with the testing data subset of the historical data before finalizing the variable structure regression model.

12. The method of claim 1, further comprising using the variable structure regression model for at least one of non-linear regression, pattern classification, data mining, well failure detection, predicting well failure, predicting pump failures, predicting hydrocarbon production, predicting output based on new data, generating a forecast of a post-fracturing response, or well design.

13. The method of claim 1, wherein the historical data includes hydraulic fracturing data, and wherein the hydraulic fracturing data includes at least one of feet of perforation, number of holes, number of stages, pad volume, slurry volume, or sand volume to predict oil production.

14. The method of claim 1, further comprising applying the variable structure regression model with a process, wherein the process is at least one of:
a fracture optimization,
an oil production prediction system,
a steam injection distribution system,
a drilling prediction system,
a steamflood wellhead system, and
a waterflood wellhead system.

15. An apparatus for generating a variable structure regression model, comprising:
a processor;
a memory, the memory storing computer-executable instructions which, when executed by the processor, cause the apparatus to perform
receiving data input including historical data from the memory, an output variable, and a plurality of input variables,
establishing, by the apparatus, a set of linguistic rules for the plurality of input variables,
establishing, by the apparatus, variable structure regression equations using the set of linguistic rules, the output variable, the input variables, and the historical data,
optimizing, by the apparatus, membership functions and regression coefficients of the variable structure regression equations, and
generating, by the apparatus, a variable structure regression model from the optimized membership functions, the regression coefficients, and the variable structure regression equations.

16. The apparatus of claim 15, wherein each input variable is described by a plurality of linguistic terms, and the computer-executable instructions which, when executed by the processor, cause the apparatus to further perform receiving a quantity for each input variable that indicates the plurality of linguistic terms.

17. The apparatus of claim 16, wherein each linguistic rule is an antecedent of the output variable, and wherein each antecedent contains the plurality of terms for the input variables.

18. The apparatus of claim 15, wherein the computer-executable instructions which, when executed by the processor, cause the apparatus to further perform, by the apparatus, dividing the historical data into at least a training data subset, a validation data subset, and a testing data subset.

19. The apparatus of claim 15, wherein the computer-executable instructions which, when executed by the processor, cause the apparatus to further perform evaluating, by the processor, the generated variable structure regression model with the testing data subset of the historical data before finalizing the variable structure regression model.

20. A method for forecasting post-fracturing responses in a subsurface reservoir, comprising:
applying, via forecasting instructions executable on a computing system, a non-linear variable structure regression model to automatically establish non-linear regressors and select a number of non-linear regressors associated with historical hydraulic fracturing data, wherein each non-linear regressor is a combination of input variables, and each input variable includes a plurality of terms; and
based on the non-linear variable structure regression model, generating a forecast of a post-fracturing response using the historical hydraulic fracturing data;
wherein the non-linear variable structure regression model determines relationships between fracturing parameters and post-fracturing productions in the form of one or more linguistic rules.
